(19) United States
(12) Patent Application Publication
(10) Pub. No.: US 2025/0330070 A1
(43) Pub. Date: Oct. 23, 2025

(54) ROTOR MANUFACTURING APPARATUS

(71) Applicant: TOYOTA BOSHOKU KABUSHIKI KAISHA, Aichi-ken (JP)

(72) Inventors: Yuto ITO, Takahama-shi (JP); Yuki WAKIMOTO, Nagoya-shi (JP)

(73) Assignee: TOYOTA BOSHOKU KABUSHIKI KAISHA, Aichi-ken (JP)

(21) Appl. No.: 19/171,600

(22) Filed: Apr. 7, 2025

(30) Foreign Application Priority Data
Apr. 17, 2024 (JP) 2024-066678

(51) Int. Cl. H02K 15/035; H02K 1/276

(52) U.S. Cl. CPC H02K 15/035; H02K 1/276

(57) ABSTRACT

A rotor manufacturing apparatus includes a first die and a second die configured to sandwich and clamp multiple rotor cores, which include magnets accommodated in slots, in an axial direction. The first die includes multiple urging sections configured to urge the rotor cores toward the second die. One of the first die and the second die includes multiple supply passages configured to supply plastic to the slots of the rotor cores. The first die and the second die are configured to sandwich and clamp the rotor cores collectively against urging forces of the urging sections.

### CROSS-REFERENCE TO RELATED APPLICATIONS

This application is based upon and claims the benefit of priority from Japanese Patent Application No. 2024-066678, filed on Apr. 17, 2024, the entire contents of which are incorporated herein by reference.

### BACKGROUND

### 1. Field

The present disclosure relates to a rotor manufacturing apparatus.

### 2. Description of Related Art

A rotor of a rotating electric machine includes a tubular rotor core and multiple magnets. The rotor core includes multiple slots extending therethrough in the axial direction. Each slot accommodates a magnet. The magnets are fixed to the rotor core with plastic filling the slots.

A rotor manufacturing apparatus disclosed in Japanese Laid-Open Patent Publication No. 2019-161850 includes a fixed die, a movable die having plastic inlet ports, and a caul plate having filling pots. The fixed die supports the lower surface of the rotor core. The caul plate is disposed on the upper surface of the rotor core. The movable die is in contact with the upper surface of the caul plate.

A thermosetting plastic is supplied to the plastic inlet ports of the movable die. The plastic in the plastic inlet ports, which is in a molten state due to the heat of the apparatus, is extruded by plungers. As a result, the plastic fills the slots via the filling pots of the caul plate and solidifies.

In the rotor manufacturing apparatus described in the above publication, there is a demand for improvement in the productivity in manufacturing rotors.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a rotor manufacturing apparatus us configured to manufacture multiple rotors collectively. Each rotor includes a tubular rotor core having slots extending therethrough in an axial direction. A magnet is accommodated in each slot. A plastic fills the slots to fix the magnets to the rotor core. The rotor manufacturing apparatus includes a first die and a second die configured to sandwich and clamp the rotor cores, including the magnets accommodated in the slots, in the axial direction. The first die includes multiple urging sections configured to urge the rotor cores toward the second die. One of the first die and the second die includes multiple supply passages configured to supply the plastic to the slots of the rotor cores. The first die and the second die are configured to sandwich and clamp the rotor cores collectively against urging forces of the urging sections.

Other features and aspects will be apparent from the following detailed description, the drawings, and the claims.

### BRIEF DESCRIPTION OF THE DRAWINGS

FIG. 1 is perspective view of a rotor according to a first embodiment.

FIG. 2 is a cross-sectional view of the rotor shown in FIG. 1.

FIG. 3 is a cross-sectional view of a rotor manufacturing apparatus according to the first embodiment.

FIG. 4 is an enlarged cross-sectional view of FIG. 3.

FIG. 5 is a cross-sectional view of a state in which an intermediate plate is in contact with a caul plate in the first embodiment.

FIG. 6 is a cross-sectional view of a state in which a fixed die and a movable die are clamped in the first embodiment.

FIG. 7 is a cross-sectional view of a state in which plastic fills slots in the first embodiment.

FIG. 8 is a cross-sectional view of a rotor manufacturing apparatus according to a second embodiment.

FIG. 9 is a cross-sectional view of a state in which a support member is in contact with a caul plate in the second embodiment.

FIG. 10 is a cross-sectional view of a state in which a fixed die and a movable die are clamped in the second embodiment.

FIG. 11 is a cross-sectional view of a state in which plastic fills slots in the second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

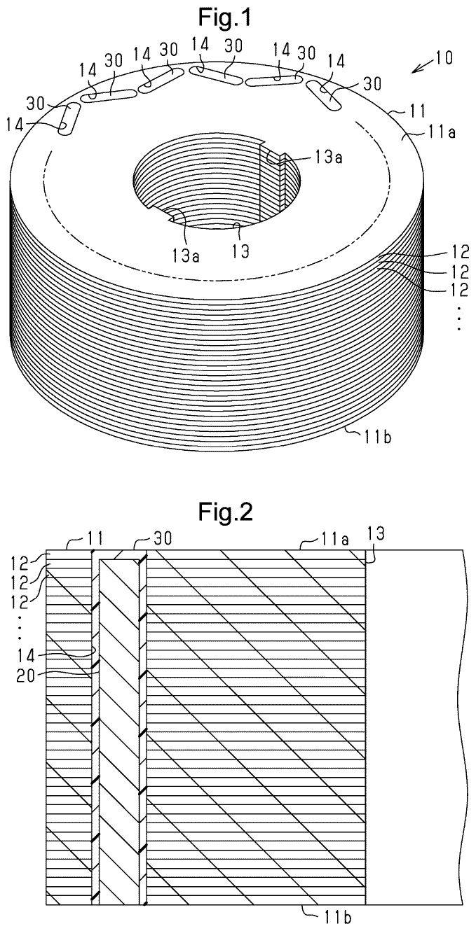

A rotor manufacturing apparatus according to a first embodiment will now be described with reference to FIGS. 1 to 7.

First, a rotor 10 manufactured by the rotor manufacturing apparatus (hereinafter, referred to as a manufacturing apparatus 40) of the present embodiment will be described.

### Rotor 10

As shown in FIGS. 1 and 2, the rotor 10 includes a rotor core 11, multiple magnets 20, and multiple pieces of plastic 30. The rotor 10 is, for example, a rotor used for a magnet-embedded motor.

The rotor core 11 is substantially cylindrical. The rotor core 11 is formed, for example, by stacking iron core pieces 12 that are punched out from a magnetic steel sheet.

In the following description, the axial direction of the rotor core 11 will simply be referred to as an axial direction. The radial direction of the rotor core 11 will simply be referred to as a radial direction. The circumferential direction of the rotor core 11 will simply be referred to as a circumferential direction.

The rotor core 11 includes a first end face 11a and a second end face 11b, which are located on opposite sides in the axial direction.

The rotor core 11 includes a center hole 13 and slots 14. A shaft (not shown) is inserted into the center hole 13. The slots 14 are formed at a distance from each other in the circumferential direction.

The center hole 13 and the slots 14 extend through the rotor core 11 in the axial direction. In other words, the center hole 13 and the slots 14 both open in the first end face 11a and the second end face 11b.

As shown in FIG. 1, the center hole 13 is substantially circular in plan view. Two protruding keys 13a, which are opposed to each other in the radial direction, are provided on the inner surface of the center hole 13. The keys 13a are fitted into keyways provided in the shaft (not shown) to restrict relative movement between the rotor core 11 and the shaft in the circumferential direction.

The cross-sectional shape of each slot 14 orthogonal to the axial direction is a substantially rectangular shape having long sides and short sides. The cross-sectional shape of each slot 14 is constant over the entire length in the axial direction.

Each slot 14 receives one of the magnets 20. The magnets 20 are fixed to the rotor core 11 by the plastic 30 filling the slots 14.

The magnets 20 are, for example, permanent magnets.

Each magnet 20 has a shape elongated in the axial direction. The length of each magnet 20 in the axial direction is shorter than the length of the rotor core 11 in the axial direction. Each magnet 20 has a substantially rectangular cross section orthogonal to the axial direction.

One end face in the axial direction of each magnet 20 is located, for example, inward from the first end face 11a in the axial direction. The other end face of each magnet 20 on the opposite side in the axial direction is, for example, flush with the second end face 11b.

The plastic 30 fills, for example, the entire circumference of each magnet 20 between the inner surface of the slot 14 and the outer surface of the magnet 20.

The plastic 30 covers one end face in the axial direction of the magnet 20 and is flush with the first end face 11a of the rotor core 11.

The plastic 30 is, for example, a thermosetting plastic.

### Manufacturing Apparatus 40

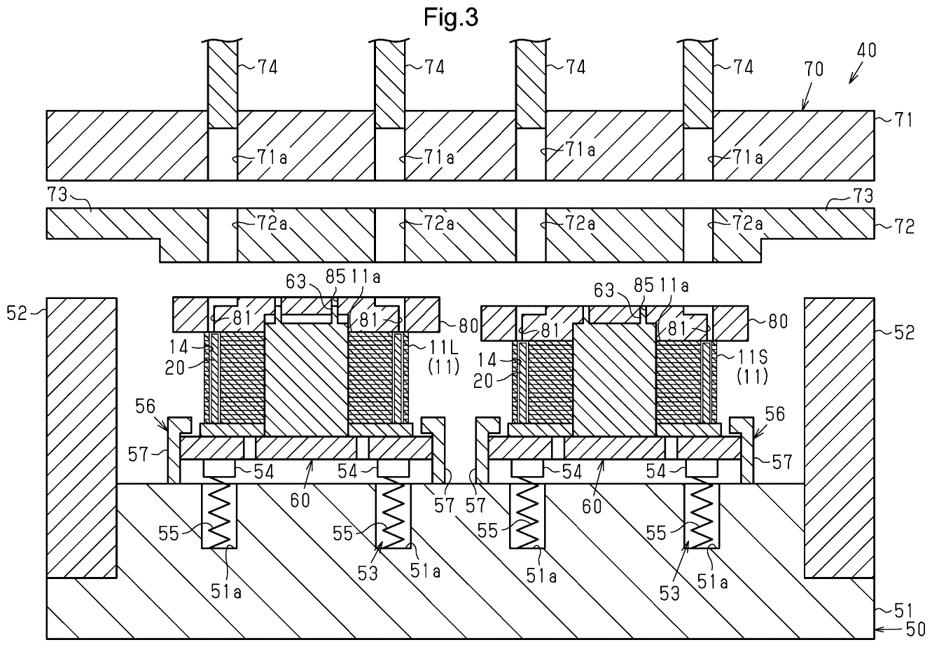

As shown in FIG. 3, the manufacturing apparatus 40 includes a fixed die 50 and a movable die 70, which are configured to be clamped and opened. The movable die 70 is disposed above the fixed die 50. The movable die 70 is configured to be moved toward and away from the fixed die 50 in the vertical direction. The fixed die 50 is an example of a first die. The movable die 70 is an example of a second die.

The manufacturing apparatus 40 includes multiple caul plates 80 placed on the first end faces 11a of the respective rotor cores 11. The fixed die 50 and the movable die 70 sandwich and clamp the rotor cores 11 via the caul plates 80 collectively.

The manufacturing apparatus 40 is configured to manufacture multiple rotors 10 collectively by filling the slots 14 of the rotor cores 11 arranged between the fixed die 50 and the movable die 70 with the plastic 30 and solidifying the plastic 30. The manufacturing apparatus 40 of the present embodiment is an apparatus configured to manufacture two rotors 10 collectively.

### Fixed Die 50

The fixed die 50 includes a support base 51, two end blocks 52, two support jigs 60, two urging sections 53, and two positioning sections 56.

The support base 51 has a flat upper surface. The support base 51 includes multiple accommodating recesses 51a in the upper surface to accommodate urging members 55, which will be discussed below.

Each end block 52 protrudes from the support base 51 toward the movable die 70. The end blocks 52 define the bottom dead center of the movable die 70 by coming into contact with the movable die 70 at the time of die clamping.

The two support jigs 60 support the two rotor cores 11 from below, respectively. The support jigs 60 are configured to be movable relative to the support base 51. The support jigs 60 also act as conveying jigs that convey the rotor cores 11 in a supported state before and after the rotors 10 are manufactured by the manufacturing apparatus 40.

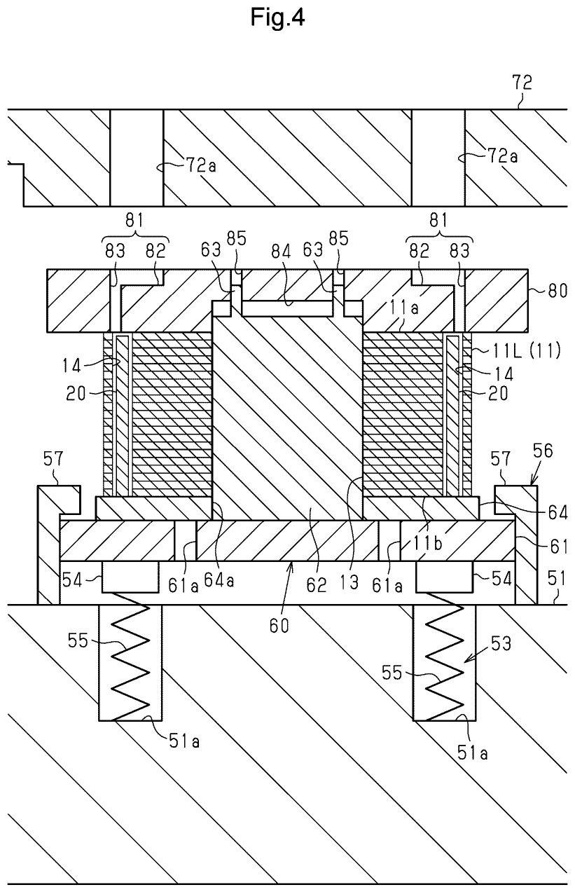

As shown in FIG. 4, each support jig 60 includes a base plate 61, a post 62, and a spacer 64. The base plate 61 is flat. The post 62 protrudes upward from a central portion of the base plate 61. The spacer 64 is stacked on the base plate 61 and supports the second end face 11b of the rotor core 11.

The base plate 61 has multiple through-holes 61a extending therethrough in the thickness direction. The through-holes 61a are provided at intervals so as to surround the post 62.

The post 62 has a columnar shape. The post 62 extends through the spacer 64. The post 62 is inserted into the center hole 13 of the rotor core 11. The post 62 includes keyways (not shown) in the outer circumferential surface. The keyways are engaged with the two keys 13a of the rotor core 11 (see FIG. 1). When the keys 13a are engaged with the keyways, the rotor core 11 is positioned relative to the support jig 60. The post 62 includes multiple positioning pins 63 on the distal end face.

The spacer 64 has the shape of a flat plate. The spacer 64 has a center hole 64a into which the post 62 is inserted. Although not illustrated, the spacer 64 is provided to be movable up and down along the post 62 by a lifting mechanism that moves through a through-hole 61a of the base plate 61. The rotor core 11 is removed from the support jig 60 by raising the spacer 64 in relation to the post 62.

As shown in FIG. 3, the two urging sections 53 respectively urge the two support jigs 60 toward the movable die 70. Specifically, each urging section 53 urges the corresponding rotor core 11 toward the movable die 70 via the corresponding support jig 60.

Each urging section 53 includes multiple support members 54 and multiple urging members 55. The support members 54 support the support jig 60 from below. The support members 54 are provided at intervals along the outer peripheral edge of the support jig 60. The urging members 55 respectively urge the support members 54 toward the movable die 70. The urging members 55 are, for example, compression coil springs.

The urging members 55 are accommodated in the accommodating recesses 51a of the support base 51. One end of each urging member 55 is connected to the bottom of the corresponding accommodating recess 51a. The other end of the urging member 55, which is on the side opposite to the end connected to the bottom the accommodating recess 51a, is connected to the corresponding support member 54.

The urging forces of the two urging sections 53 are identical. Specifically, the combined spring constants of the two urging sections 53 are identical.

The two positioning sections 56 respectively position the two support jigs 60. The positioning sections 56 each have two guide rails 57 protruding from the upper surface of the support base 51. The guide rails 57 are located on opposite sides of the support jig 60 in a planar direction of the upper surface of the support base 51 and extend in parallel to each other. The upper ends of the two guide rails 57 protrude toward each other so as to cover ends of the base plate 61 from above (see FIG. 4).

Each support jig 60 is disposed between the corresponding two guide rails 57 and is movable along the guide rails 57. The support jig 60 is positioned relative to the support base 51 by being disposed between the two guide rails 57. The two positioning sections 56 restrict the two support jigs 60 from moving toward each other.

### Movable Die 70

The movable die 70 includes a pressure plate 71, an intermediate plate 72, and multiple plungers 74.

A die clamping force for clamping the fixed die 50 and the movable die 70 is applied to the pressure plate 71.

The pressure plate 71 has multiple first through-holes 71a into which the plungers 74 are respectively inserted. The first through-holes 71a extend through the pressure plate 71 in the thickness direction.

The intermediate plate 72 is disposed below the pressure plate 71. The intermediate plate 72 is connected to the pressure plate 71 by a coupling member (not shown) so as to be movable vertically.

The intermediate plate 72 includes multiple second through-holes 72a into which the plungers 74 are respectively inserted. The second through-holes 72a extend through the intermediate plate 72 in the thickness direction. The second through-holes 72a are provided at positions corresponding to the first through-holes 71a.

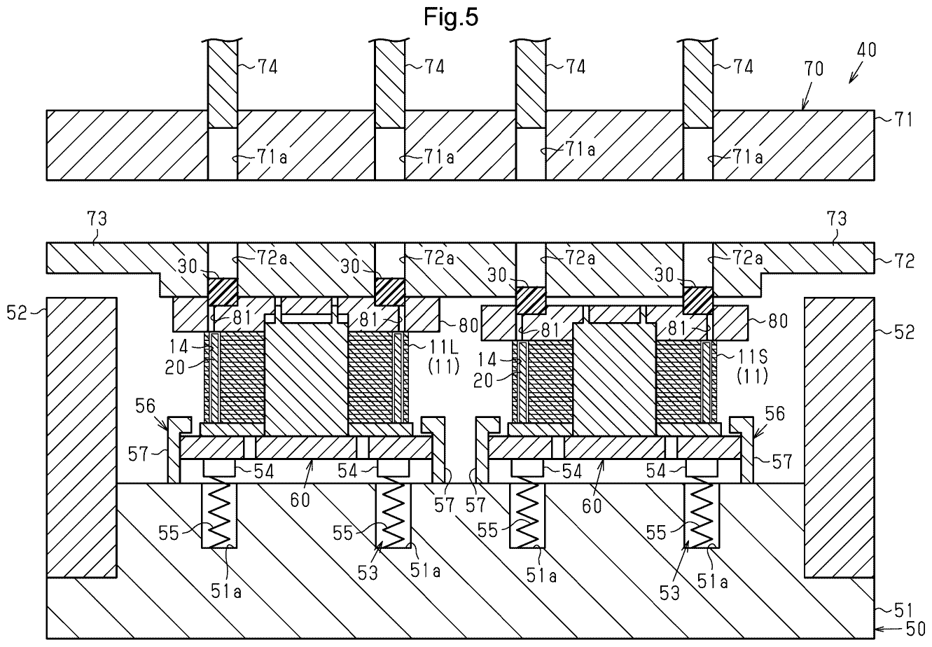

Pellets of the plastic 30 are disposed in the second through-holes 72a (see FIG. 5). For example, the plastic 30 is melted inside the second through-holes 72a by heat of the manufacturing apparatus 40. The second through-holes 72a act as passages through which the plastic 30 is supplied to the slots 14 of the rotor core 11 via connecting passages 81 of the caul plates 80, which will be discussed below. The second through-holes 72a are examples of supply passages.

The intermediate plate 72 includes facing portions 73 that face the end blocks 52 in the vertical direction. The facing portions 73 come into contact with the end blocks 52 at the time of die clamping.

The plungers 74 are configured to be retractable with respect to the lower surface of the pressure plate 71. The plungers 74 pressurize the molten plastic 30 inside the second through-holes 72a to fill the slots 14.

### Caul Plates 80

As shown in FIG. 4, each caul plate 80 is placed on the first end face 11a of the corresponding rotor core 11 supported by the corresponding support jig 60. The caul plate 80 has the connecting passages 81, which connect the second through-holes 72a of the intermediate plate 72 to the slots 14.

The connecting passages 81 each include a runner portion 82 and a conduit hole 83. The runner portion 82 opens in the upper surface of the caul plate 80. The conduit hole 83 opens in the bottom surface of the runner portion 82 and extends through the caul plate 80 in the thickness direction. The conduit hole 83 connects the runner portion 82 to the corresponding slot 14.

The caul plate 80 includes a recess 84 and positioning holes 85. The recess 84 opens in the lower surface of the central portion of the caul plate 80. The positioning holes 85 open in the upper surface of the recess 84 and extend through the caul plate 80 in the thickness direction.

The recess 84 receives the distal end of the corresponding post 62. The positioning pins 63 of the post 62 are inserted into the positioning holes 85. By inserting the positioning pins 63 into the positioning holes 85, the caul plate 80 is positioned relative to the support jig 60. Accordingly, the connecting passages 81 and the slots 14 are connected to each other.

### Manufacturing Procedure of the Rotor 10

Next, a manufacturing procedure of the rotor 10 using the manufacturing apparatus 40 will be described by taking, as an example, a case in which two rotors 10 having different dimensions in the axial direction are manufactured within a range of manufacturing tolerance of the rotor 10.

In the following description, of the two rotor cores 11 having different dimensions in the axial direction, the rotor core 11 having a larger dimension may be referred to as a rotor core 11L, and the rotor core 11 having a smaller dimension may be referred to as a rotor core 11S. In the present embodiment, the rotor core 11L and the rotor core 11S are different from each other in the number of the iron core pieces 12 to be stacked, so that the dimensions in the axial direction are different from each other.

When the rotors 10 are manufactured, first, the magnets 20 are accommodated in the slots 14 of the two rotor cores 11 respectively supported by the two support jigs 60.

Next, the caul plate 80 is placed on the first end face 11a of each of the two rotor cores 11. At this time, the positioning pins 63 are inserted into the positioning holes 85.

Next, the support jigs 60, the rotor cores 11, and the caul plates 80 are preheated to a specified temperature by placing the support jigs 60 in a heating device (not shown). Further, the fixed die 50 and the movable die 70 are preheated to a specified temperature.

Next, as shown in FIG. 3, the two support jigs 60 are disposed between the fixed die 50 and the movable die 70. Specifically, a conveyor (not shown) places each support jig 60 between the corresponding pair of the guide rails 57 while moving the support jig 60 along the guide rails 57, and then places the support jig 60 on the support members 54.

Next, as shown in FIG. 5, the intermediate plate 72 is lowered so that the intermediate plate 72 comes into contact with the upper surface of the caul plate 80 corresponding to the rotor core 11L. At this time, a gap exists between the lower surface of the intermediate plate 72 and the caul plate 80 corresponding to the rotor core 11S.

Thereafter, pellets of the plastic 30 are disposed in the second through-holes 72a. The plastic 30 disposed in the second through-holes 72a is melted by the heat of the preheating.

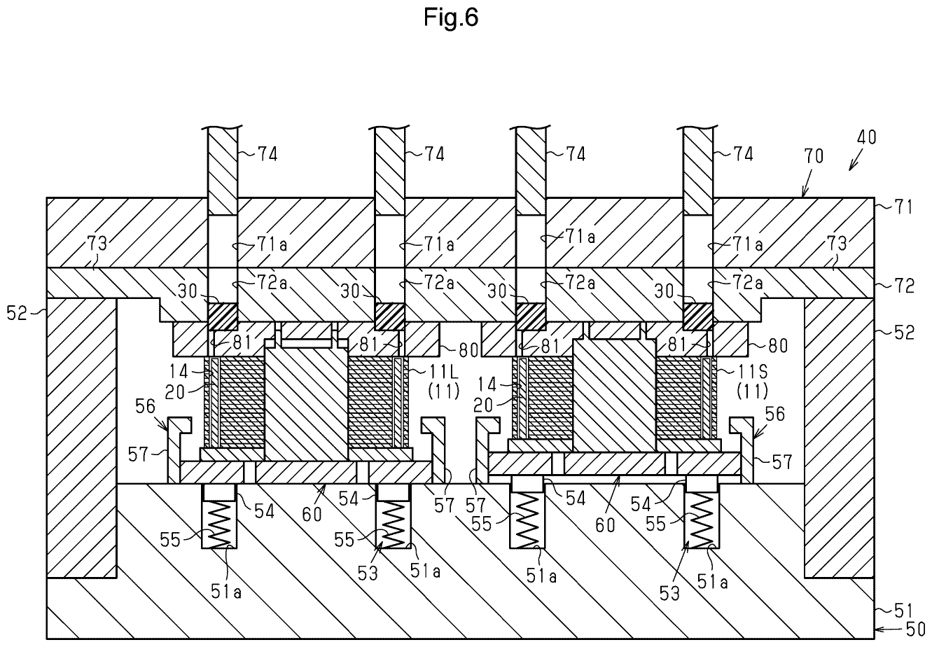

Next, as shown in FIG. 6, the pressure plate 71 is lowered to press the intermediate plate 72 downward. As the pressure plate 71 is lowered, the intermediate plate 72 first presses the caul plate 80 corresponding to the rotor core 11L. Accordingly, the urging member 55 of the urging section 53 corresponding to the rotor core 11L is compressed. Subsequently, the intermediate plate 72 presses the caul plate 80 corresponding to the rotor core 11S. Accordingly, the urging member 55 of the urging section 53 corresponding to the rotor core 11S is compressed. The pressure plate 71 presses the two caul plates 80 collectively toward the support base 51 via the intermediate plate 72. In this state, since each support jig 60 is urged toward the movable die 70 by the urging section 53, the upper surface of each caul plate 80 is pressed against the lower surface of the intermediate plate 72. As described above, the fixed die 50 and the movable die 70 sandwich and clamp the two rotor cores 11 collectively in the axial direction via the two caul plates 80 against the urging forces of the two urging sections 53.

In the present embodiment, since the dimensions in the axial direction of the rotor core 11L and the rotor core 11S are different from each other, the compression amount of the urging member 55 corresponding to the rotor core 11L and the compression amount of the urging member 55 corresponding to the rotor core 11S at the time of die clamping are different from each other. Specifically, the compression amount of the urging member 55 corresponding to the rotor core 11L is larger than the compression amount of the urging member 55 corresponding to the rotor core 11S. Therefore, at the time of die clamping, the lower surface of the support jig 60 supporting the rotor core 11S is positioned higher than the lower surface of the support jig 60 supporting the rotor core 11L. The lower surface of the support jig 60 that supports the rotor core 11L may be positioned above the upper surface of the support base 51.

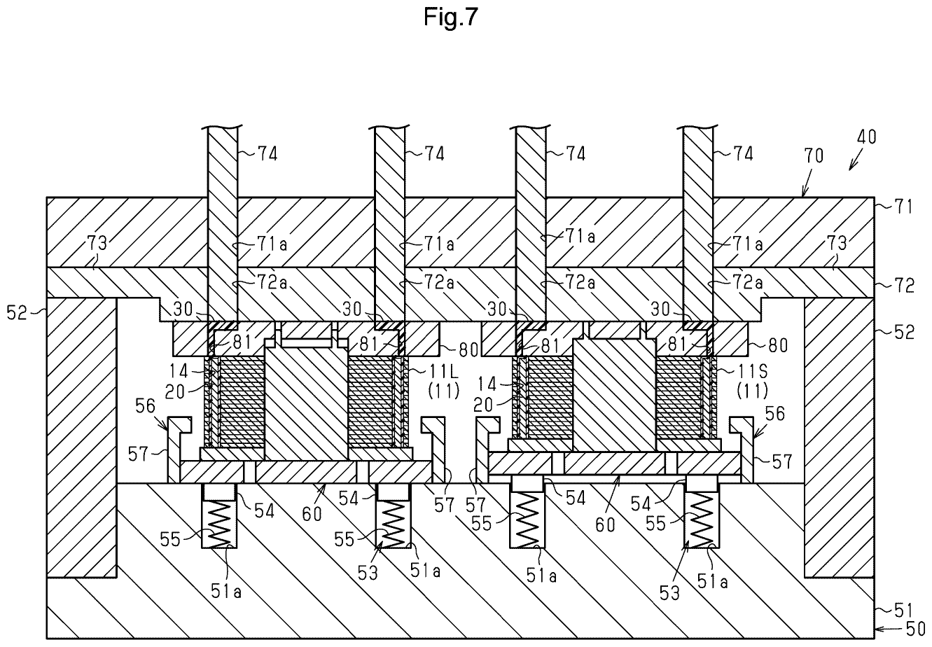

Next, as shown in FIG. 7, the plungers 74 are lowered, so that the molten plastic 30 is pressurized inside the second through-holes 72a and the connecting passages 81. Accordingly, the interior of each slot 14 is filled with the plastic 30 via the connecting passage 81 of the caul plate 80. The plastic 30 filling the slots 14 is solidified by being heated by the heat of the preheating. The magnets 20 are thus fixed to the rotor core 11.

Thereafter, the fixed die 50 and the movable die 70 are opened, so that the intermediate plate 72 is separated from the caul plates 80. Then, the caul plates 80 are taken out of the manufacturing apparatus 40, and the rotors 10 are removed from the support jigs 60.

Two rotors 10 are manufactured in the above-described manner.

### Operation of the Present Embodiment

The fixed die 50 and the movable die 70 sandwich and clamp two rotor cores 11 collectively in the axial direction against the urging forces of the two urging sections 53. In this state, the plastic 30 is supplied to the slots 14, in which the magnets 20 are accommodated, via the second through-holes 72a, so that the magnets 20 are fixed to the rotor cores 11.

When the fixed die 50 and the movable die 70 sandwich and clamp two rotor cores 11 collectively, the following problems may occur if the dimensions of the two rotor cores 11 in the axial direction are different from each other. The rotor core 11S, which has a smaller axial dimension, may fail to be clamped between the fixed die 50 and the movable die 70. In this case, due to the dimensional difference between the two rotor cores 11, a gap through which the plastic 30 leaks may be generated in the manufacturing apparatus 40 at the time of die clamping.

In this regard, according to the above-described configuration, the two rotor cores 11 are urged toward the movable die 70 by the two urging sections 53, respectively. Therefore, the dimensional difference between the two rotor cores 11 is absorbed by the two urging sections 53, so that a gap from which the plastic 30 leaks is less likely to be formed in the manufacturing apparatus 40 at the time of die clamping.

### Advantages of the Present Embodiment

(1-1) The fixed die 50 includes the multiple urging sections 53 that urge multiple rotor cores 11 toward the movable die 70. The movable die 70 has the multiple second through-holes 72a for supplying the plastic 30 to the slots 14 of the multiple rotor cores 11. The fixed die 50 and the movable die 70 sandwich and clamp the rotor cores 11 collectively against the urging forces of the urging sections 53.

According to the above-described configuration, the two rotors 10 are manufactured collectively. Therefore, the productivity in manufacturing the rotors 10 is improved.

(1-2) The fixed die 50 and the movable die 70 sandwich and clamp two rotor cores 11 collectively via the two caul plates 80.

For example, in a case in which the second through-holes 72a and the slots 14 are directly connected to each other, there is a possibility that some of the plastic 30, which has been injected into the slots 14 and solidified, remains in the second through-holes 72a. In this case, in order to continuously manufacture rotors 10, it is necessary to remove the plastic 30 remaining in the second through-holes 72a each time rotors 10 are manufactured. Therefore, it is difficult to manufacture the next rotors 10 until the plastic 30 is removed.

In this regard, according to the above-described configuration, since the second through-holes 72a and the slots 14 are connected to each other via the connecting passages 81 of the caul plates 80, some of the plastic 30 that has been injected into the slots 14 and solidified remains in the connecting passages 81. Therefore, by separating the caul plates 80 from the rotor cores 11 after the plastic 30 is solidified, the plastic 30 in the slots 14 and the plastic 30 in the connecting passages 81 are separated from each other. Therefore, by preparing new caul plates 80, the manufacture of the next rotors 10 can be started at an early stage. Therefore, the productivity in manufacturing the rotors 10 is improved.

(1-3) The urging forces of the two urging sections 53 are identical.

With this configuration, the structures of the two urging sections 53 can be standardized. This reduces the complexity of the configuration of the manufacturing apparatus 40.

(1-4) The manufacturing apparatus 40 includes the two positioning sections 56.

With this configuration, each rotor core 11 disposed between the fixed die 50 and the movable die 70 is positioned. Therefore, the slots 14 of each rotor core 11 is filled with the plastic 30 in a preferred manner.

### Second Embodiment

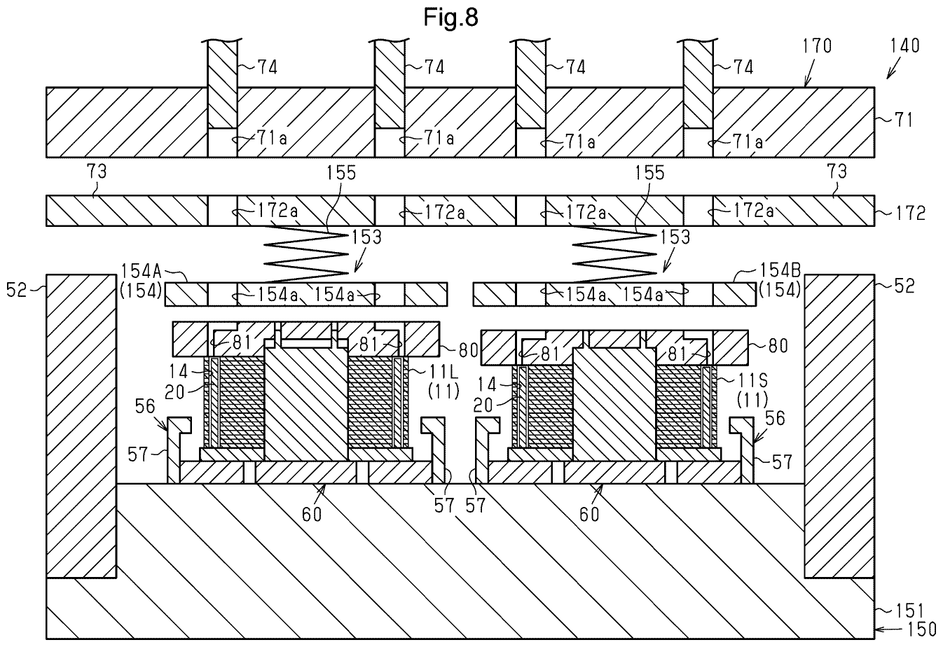

A rotor manufacturing apparatus 140 according to a second embodiment will now be described with reference to FIGS. 8 to 11.

In the second embodiment, the same reference numerals are given to those components that are the same as those in the first embodiment. Also, reference numerals 1**, which are obtained by adding 100 to the reference numerals ** in the first embodiment, are given to the corresponding components, and redundant explanations are omitted.

As shown in FIG. 8, the manufacturing apparatus 140 includes a fixed die 150 and a movable die 170, which are configured to be clamped and opened. The fixed die 150 is an example of a second die. The movable die 170 is an example of a first die.

The fixed die 150 includes a support base 151, two end blocks 52, two support jigs 60, and two positioning sections 56.

The upper surface of the support base 151 supports the two support jigs 60.

The movable die 170 includes a pressure plate 71, an intermediate plate 172, multiple plungers 74, and two urging sections 153.

The intermediate plate 172 includes multiple second through-holes 172a into which the plungers 74 are respectively inserted.

Each urging section 153 includes a support member 154 and an urging member 155. The urging section 153 is disposed on a side of the corresponding rotor core 11 opposite to the support jig 60.

The support member 154 has the shape of a flat plate. The support member 154 supports the upper surface of the corresponding caul plate 80 at the time of die clamping. The outer shape of the support member 154 is larger than the outer shape of the caul plate 80. The support member 154 has multiple third through-holes 154a into which the plungers 74 are inserted, respectively. The third through-holes 154a extend through the support member 154 in the thickness direction. The third through-holes 154a are provided at positions facing the second through-holes 172a. The third through-holes 154a are examples of supply passages.

The urging members 155 urge the support members 154 toward the fixed die 150. The urging members 155 are compression coil springs. One end of each urging member 155 is connected to the lower surface of the intermediate plate 172. The other end of the urging member 155, which is on the side opposite to the end connected to the lower surface of the intermediate plate 172, is connected to the support member 154.

### Manufacturing Procedure of the Rotor 10

Next, a manufacturing procedure of the rotors 10 using the manufacturing apparatus 140 will be described focusing on differences from the first embodiment.

In the following description, of the two support members 154, the support member 154 located above the rotor core 11L may be referred to as a support member 154A, and the support member 154 located above the rotor core 11S may be referred to as a support member 154B.

As shown in FIG. 8, the two rotor cores 11 supported by the two support jigs 60 are disposed between the fixed die 150 and the movable die 170. Specifically, a conveyor (not shown) places each support jig 60 between the corresponding pair of the guide rails 57 while moving the support jig 60 along the guide rails 57, and then places the support jig 60 on the support base 151.

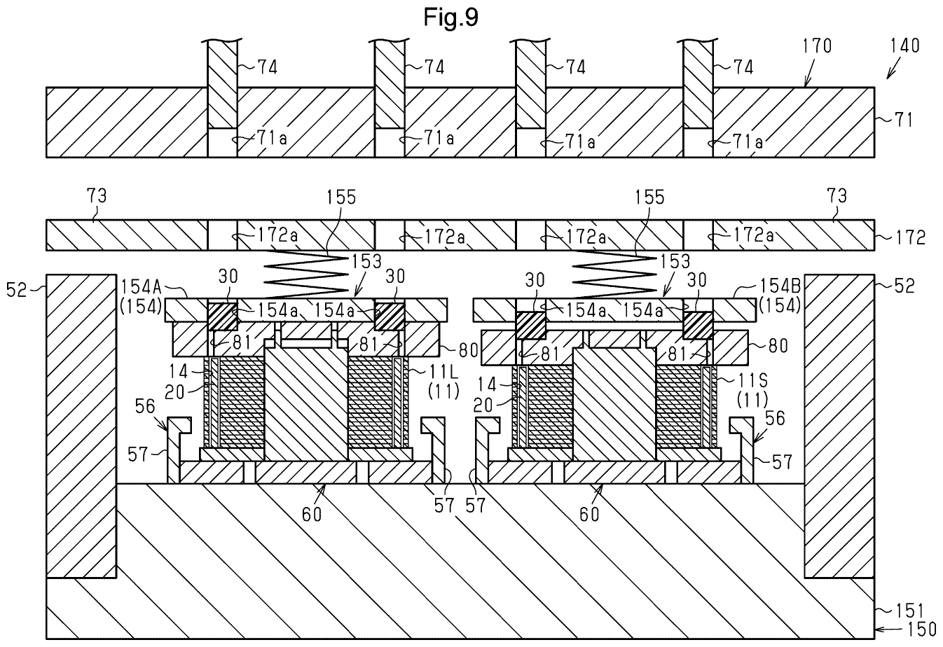

Next, as shown in FIG. 9, the intermediate plate 172 is lowered so that the support member 154A comes into contact with the upper surface of the caul plate 80 corresponding to the rotor core 11L. At this time, a gap exists between the lower surface of the support member 154B and the caul plate 80 corresponding to the rotor core 11S.

Thereafter, pellets of the plastic 30 are disposed in the third through-holes 154a. The plastic 30 disposed in the third through-holes 154a is melted by the heat of the preheating.

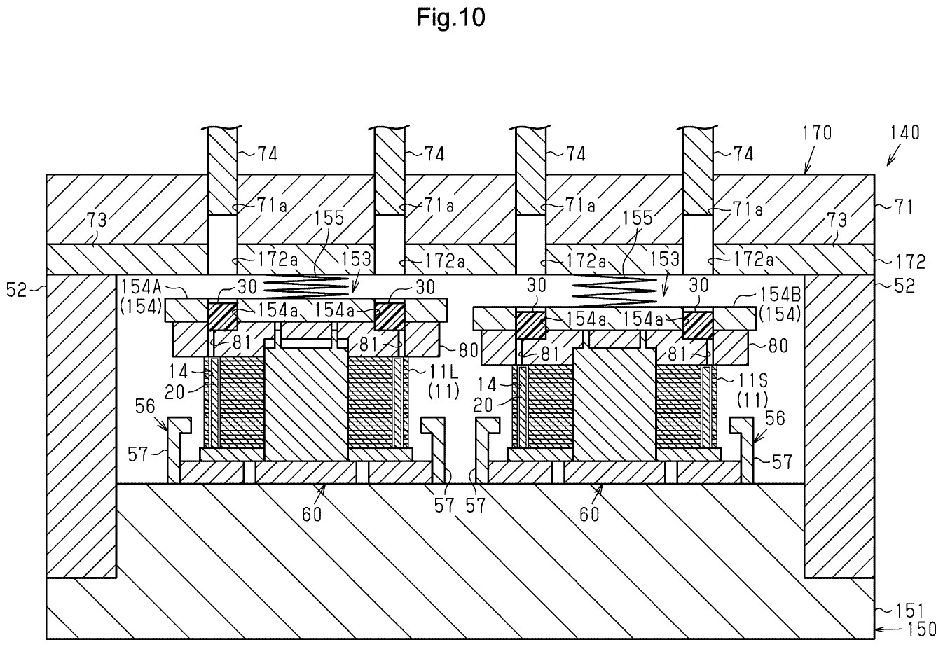

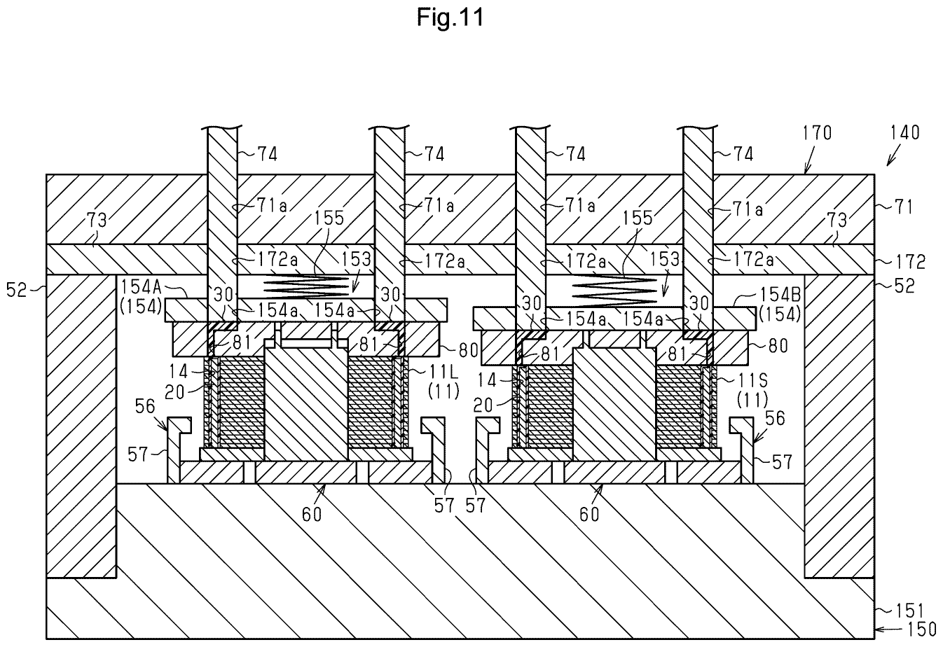

Next, as shown in FIG. 10, the pressure plate 71 is lowered to press the intermediate plate 172 downward. As the pressure plate 71 is lowered, the urging member 155 that urges the support member 154A is compressed. Also, as the pressure plate 71 is lowered, the support member 154B comes into contact with the upper surface of the caul plate 80 corresponding to the rotor core 11S, and then the urging member 155 that urges the support member 154B is compressed. The pressure plate 71 presses the two caul plates 80 collectively toward the support base 151 via the intermediate plate 72 and the two urging sections 153. In this state, since each support member 154 is urged toward the fixed die 150 by the corresponding urging member 155, the lower surface of the support member 154 is pressed against the upper surface of the corresponding caul plate 80. As described above, the fixed die 150 and the movable die 170 sandwich and clamp the two rotor cores 11 collectively in the axial direction via the two caul plates 80 against the urging forces of the two urging sections 153.

Next, as shown in FIG. 11, the plungers 74 are lowered, so that the molten plastic 30 is pressurized inside the third through-holes 154a and the connecting passages 81. Accordingly, the interior of each slot 14 is filled with the plastic 30 via the connecting passage 81 of the caul plate 80. The plastic 30 filling the slots 14 is solidified by being heated by the heat of the preheating. The magnets 20 are thus fixed to the rotor core 11.

Thereafter, the fixed die 150 and the movable die 170 are opened, so that the support members 154 are separated from the caul plates 80. Then, the caul plates 80 are taken out of the manufacturing apparatus 140, and the rotors 10 are removed from the support jigs 60.

Two rotors 10 are manufactured in the above-described manner.

### Operation of the Present Embodiment

The fixed die 150 and the movable die 170 sandwich and clamp two rotor cores 11 collectively in the axial direction against the urging forces of the two urging sections 153. In this state, the plastic 30 is supplied to the slots 14, in which the magnets 20 are accommodated, via the third through-holes 154a, so that the magnets 20 are fixed to the rotor cores 11.

The two rotor cores 11 are urged toward the fixed die 150 by the two urging sections 153, respectively. Therefore, the dimensional difference between the two rotor cores 11 is absorbed by the two urging sections 153, so that a gap from which the plastic 30 leaks is less likely to be formed in the manufacturing apparatus 140 at the time of die clamping.

### Advantages of the Present Embodiment

The manufacturing apparatus 140 according to the present embodiment achieves advantages similar to the advantages (1-1) to (1-4) of the first embodiment.

### Modifications

The above-described embodiments may be modified as follows. The above-described embodiments and the following modifications can be combined as long as the combined modifications remain technically consistent with each other.

Hereinafter, modifications of the first embodiment will be described, but the modifications can be similarly applied to the second embodiment as long as the combined modifications remain technically consistent with each other.

The plastic 30 may be a thermoplastic.

The fixed die 50 does not necessarily need to include the positioning sections 56.

The urging forces of the urging sections 53 may be different from each other. In this case, the urging force of each urging section 53 is preferably greater than or equal to an urging force required for applying a desired die clamping force to the rotor cores 11 at the time of die clamping.

The manufacturing apparatus 40 does not necessarily need to include the caul plates 80. In this case, the second through-holes 72a and the slots 14 may be directly connected to each other.

The movable die 70 may be disposed below the fixed die 50.

Each urging section 53 may include one support member 54 and one urging member 55.

In place of compression coil springs, the urging members 55 may be leaf springs, hydraulic cylinders, or electric cylinders.

The manufacturing apparatus 40 may be configured to manufacture three or more rotors 10.

Supply passages for supplying the plastic 30 to the slots 14 may be provided in the fixed die 50. In this case, the caul plates 80 may be omitted, and the connecting passages 81 may be formed in the support jigs 60. In place of the support jigs 60, the caul plates 80 may be disposed between the support base 51 and the rotor cores 11.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A rotor manufacturing apparatus configured to manufacture multiple rotors collectively, each rotor including a tubular rotor core having slots extending therethrough in an axial direction, a magnet accommodated in each slot, and a plastic filling the slots to fix the magnets to the rotor core, the rotor manufacturing apparatus comprising:
a first die and a second die configured to sandwich and clamp the rotor cores, including the magnets accommodated in the slots, in the axial direction, wherein
the first die includes multiple urging sections configured to urge the rotor cores toward the second die,
one of the first die and the second die includes multiple supply passages configured to supply the plastic to the slots of the rotor cores, and
the first die and the second die are configured to sandwich and clamp the rotor cores collectively against urging forces of the urging sections.

2. The rotor manufacturing apparatus according to claim 1, further comprising:
multiple caul plates each having connecting passages connecting the supply passages to the slots, each caul plate being configured to be disposed on one end face of one of the rotor cores in the axial direction, and
the first die and the second die are configured to sandwich and clamp the rotor cores collectively via the caul plates.

3. The rotor manufacturing apparatus according to claim 1, wherein urging forces of the urging sections are identical.

4. The rotor manufacturing apparatus according to claim 1, further comprising multiple positioning sections configured to position each of the rotor cores disposed between the first die and the second die.
